(19) United States
(12) Patent Application Publication
(10) Pub. No.: US 2006/0071190 A1
(43) Pub. Date: Apr. 6, 2006

(54) Linear valve actuator

(76) Inventor: Jean-Francois Pfister, Sonceboz (CH)

Correspondence Address: Clifford W. Browning;Woodard Emhardt, Bank One Center/Tower, 111 Monument Circle, Suite 3700, Indianapolis, IN, 46204-5137, US

(21) Appl. No.: 10/532,896

(22) PCT Filed: Sep. 24, 2003
(86) PCT No.: PCT/CH03/00640

§ 371 Date: Apr. 27, 2005

(30) Foreign Application Priority Data
Oct. 28, 2002 (CH) 1799/02

(51) Int. Cl. F16K 31/02

(52) U.S. Cl. 251/129.11

(57) ABSTRACT

A linear actuator for the control of a valve, includes a motor portion (2) and an actuator device portion (3) comprising a rotatable member (9) provided with a threaded portion (10) matching the threaded portion of a linear displacement threaded bolt (11) the rotatable member being supported by bearings (15, 16) and drivable in rotation by the motor portion. The linear actuator further includes an axially compressible coil spring (19) mounted in a compressed state between a valve head (37) arranged at one end of the threaded bolt (11) and the casing of the actuator, wherein the threaded portion (10) of the threaded bolt is comprised of at least one thread arranged at an angle α relative to a plane orthogonal to the axial direction of motion of the threaded bolt and wherein the characteristic tan (α) exceeds the friction coefficient μ between the threaded bolt and the rotatable member, so that the motion of the threaded bolt is reversible.

The present invention relates to a linear actuator including a member driven in rotation by an electric motor, for linear displacement of a valve portion.

The linear actuator can be used, in particular, for controlling a valve of a gas burner. Linear actuators are quite widespread and they are used in many different applications, examples of which are described in International Patent Application WO 01/89062 A1 and the European Patent EP 0987477. The devices described in these applications include a stepping motor driving a threaded bolt-nut system for producing the linear displacement of a shaft integral with a threaded bolt. The stepping motor enables the shaft of the threaded bolt to be rapidly displaced and positioned with few mechanical parts and using a relatively simple control means.

In EP-A-987477, the actuator is designed for controlling the valve of a gas burner and includes a valve head of a gas burner which is shaped as a cone and which is received in a valve seat having a matching shape, in order to close the gas conduit on which the valve is mounted.

In a gas supply system, it is important that the valve closes automatically in case of an interruption of the electric current fed to the control system of the valve. In the actuator described in the latter patent cited above, the so-called “failsafe” safety function operating in the case of a current interruption is performed by a clock spring, an end of which is fixed to an end of the threaded bolt. The clock spring applies a torque to the threaded bolt such as to rotate the same in the direction of closure of the valve. In the case of an interruption of the current to the motor of the linear actuator, an automatic closure of the valve takes place, through the action of the clock spring, upon the threaded bolt.

A significant drawback of the above-mentioned device is that the clock spring is fixed to the threaded bolt which accordingly limits considerably the linear displacement of this threaded bolt. Moreover, the system requires a longer linear threaded bolt and, consequently, also a bulkier casing for housing the clock spring.

Another drawback of this system is that the mounting of the clock spring is not carried out without difficulty and this has a negative impact on the cost of assembling and of producing the actuator.

In view of these drawbacks, an object of the invention is to provide a linear actuator of the threaded bolt-nut type for the control of a valve with a so-called “failsafe” safety system, which would be effective, reliable and inexpensive to manufacture and to assemble.

It is also advantageous to provide a linear actuator of the above-cited type which is compact, rigid and accurate.

Objects of the invention are achieved by a linear actuator in accordance with claim 1.

In the present invention, the linear actuator for controlling a valve, includes a motor portion and an actuator device portion, comprising a rotatable member having a threaded portion matching the threaded portion of a threaded bolt capable of a linear motion, the rotatable member being supported by bearings and being drivable in rotation by the motor portion. The linear actuator further includes an axially compressible coil spring mounted in a compressed state between a valve portion arranged at one end of the threaded bolt and the casing of the actuator, the threaded portions of the actuator comprising threads arranged at an angle α relative to a plane orthogonal to the axial direction of displacement of the threaded bolt, wherein the characteristic tan (α) exceeds the friction coefficient μ between the threaded bolt and the rotatable member so that the threaded bolt is reversible.

Advantageously, in the case of an interruption of the electrical current supply, the compressed coil spring moves the valve head axially until the same reaches its closed position, in a reliable manner, owing to the reversibility of the threaded bolt-nut system, in a construction which is relatively simple to manufacture and to assemble.

Furthermore, the axial stroke of the threaded bolt may be relatively long without adversely affecting the performance and reliability of the system, while at the same time allowing the actuator to have a very rigid and compact construction.

Other objects and other advantageous aspects of the invention will be apparent from the claims, the description, and the appended drawing, in which:

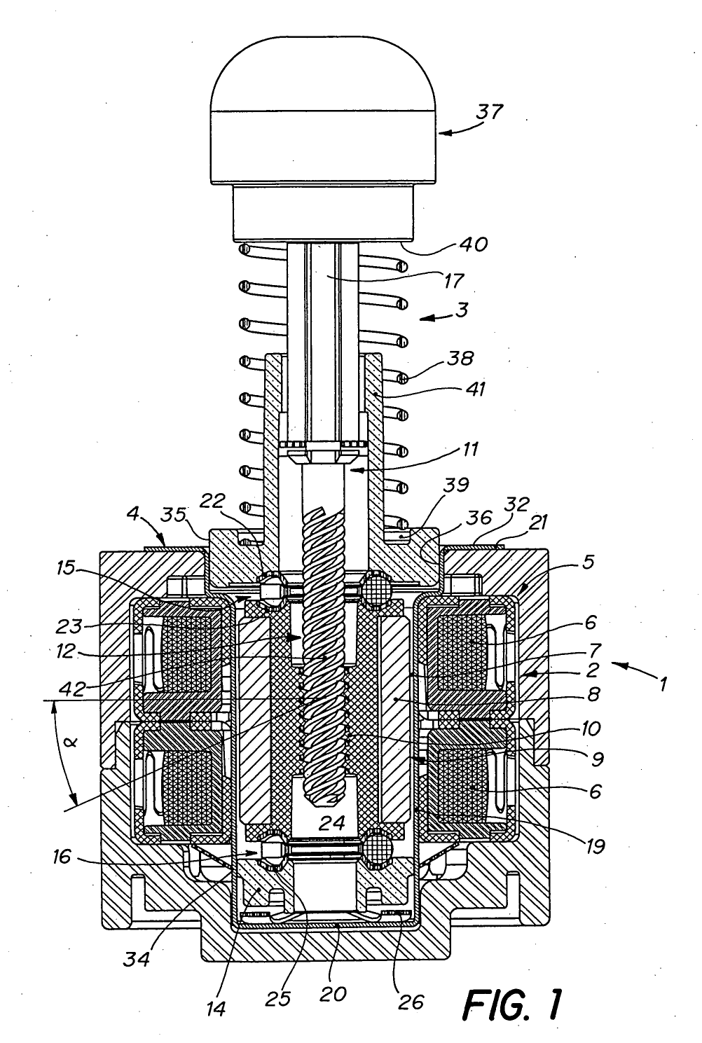

FIG. 1 is a cross-sectional view of a linear actuator of the threaded bolt-nut type, used for the control of a valve in accordance with the invention.

With reference to FIG. 1, an actuator 1 includes an electric motor portion 2, an actuator portion 3 and a conductive partition wall 4. The partition wall 4, which is located between the actuator part 3 and the motor portion 2, is continuous and extends to the outside of the actuator, thus ensuring a highly effective and reliable electrical and physical insulation between these portions. The electric motor portion 2 includes a stepping motor, which has features similar to those of conventional stepping motors, such as the stator 5 having two coil parts 6 spaced apart by an air gap 7 from permanent magnets 8, which are mounted on a rotatable member 9 of the actuator part 3. The use of a stepping motor is advantageous in that it makes it possible to adjust easily and rapidly the position of the member which is to be controlled, with a construction which is compact and inexpensive.

Other types of reversible motors can, however, be used in the present invention.

The actuator part 3 includes a rotatable member 9 which has a threaded part 10 engaged with a matching member provided as a threaded bolt 11 having a threaded portion 12, a cover 13, a body portion 14 and bearings 15, 16 for supporting axially and radially the rotatable member 9.

The rotation of the rotatable member 9 produces an axial motion of the threaded bolt 11, which is provided with an axial guide member or part 17, which co-operates with an axial guide member or part matching the cover 13, to stop the rotation of the threaded bolt. The threaded bolt 11 is coupled at one end with a valve head 37 designed for being nested in a matching seat of a valve (not illustrated) for controlling the flow of a combustible gas in a system designed for supplying or feeding a combustible gas, a specific example being a system for adjusting the flow rate of a gas burner.

The actuator further includes a coil spring 38, mounted axially in a compressed state between the valve head 37 and the casing of the actuator, in particular the cover 13. One end of the coil spring 19 is positioned in a housing 39 of the cover 13 and the other end is positioned in a housing 40 of the valve head 37. The spring 38 can be mounted about the threaded bolt 11 of the cover 13 before the mounting of the valve head 37 on the threaded bolt 11, for instance via a threaded means or some other fastening means. Accordingly, the compressed coil spring 19 exerts an axial force on the threaded bolt and on the valve head 37 in the direction of the valve seat, which makes it possible for the valve to close in the case of the power supply to the stepping motor being interrupted.

In order to make possible the axial motion of the threaded bolt upon the occurrence of an interruption of the power supply, the threads 42 of the threaded portions 10, 12 of respectively the rotatable member 9 and of the threaded bolt 11 slant at an angle α of which the value tan (α) exceeds that of the friction coefficient μ, between the threaded bolt and the rotatable member. In view of the fact that this angle α of the threads is relatively high, the threaded parts can be provided with two, three or even four threads.

Advantageously, this construction in accordance with the invention makes it possible to provide a control system for a valve which guarantees a high level of safety in the case of a failure, which has a structure comprised of only a few parts and which is inexpensive and easily assembled. In the embodiment illustrated, the coil spring 38 can be assembled on the outside of the actuator before the mounting of the valve head 37 on the threaded bolt 11. Furthermore, the axial stroke of the valve part can be relatively long.

The partition wall 4 has a cylindrical portion 19 in the air gap 7 between the stator 5 and the magnets 8 on the rotatable member 9, a bottom portion 20 and an outer portion 21 which is provided as a flange having a surface 32 designed for being mounted against a support or a wall of a device which is to be controlled. The partition wall 4 or at least the portion 19 thereof in the air gap 7 can be made of a material with a good magnetic permeability, in order to increase the magnetic current between the stator 5 and the magnets 8.

The stator 5 of the motor is positioned around the partition wall 4 and the actuator portion 3 is positioned inside the cylindrical portion 19, respectively via the axial and radial positioning surfaces 33, 34 of the body portion 14 and via the positioning surfaces 35 of the cover 13, with all these surfaces abutting against the partition wall. The cover 13 is force-fitted into a matching cylindrical cavity 36 of the partition wall.

Advantageously, the partition wall is also a structural component that allows assembly of the motor portion with the actuator portion 3. The bearings 15, 16 of the rotatable member are provided in the form of ball thrust bearings with three or four points of contact for the axial and the radial positioning of the rotatable member, with a bearing being arranged on each side of the threaded portion 10 of the rotatable member. One of the bearings 15 is arranged between the cover portion 13 and the rotatable member 9 and the other bearing 16 is arranged between the rotatable member and the body portion 14 which is mounted against the partition wall 4. The ball-bearing rails 22, 23 of the bearing 15 are integral, respectively, with the cover 13 and with the rotatable member 9 and the ball-bearing rails 24, 25 of the ball abutment 16 are integral, respectively, with the rotatable member 9 and with the body portion 14.

An elastic disk 26 mounted between the bottom 20 of the partition wall and the body portion 14 eliminates any axial slack and regulates the axial force applied upon the bearings 15, 16.

Advantageously, the actuator is made from only a few parts which are easily assembled, thus reducing considerably the manufacturing costs. The body portion 14, the ball bearings, the rotatable member and the cover can be assembled by an insertion into the partition wall, carried out along the axial direction, which facilitates the automation of the assemblage procedures required for the actuator, with the cover 13 being simply force-fitted into a housing defined by the partition wall.

1-6. (canceled)

7. A linear actuator for control of a valve, including a motor portion (2) and an actuator device portion (3) comprising a rotatable member (9) provided with a threaded portion (10) matching the threaded portion (12) of a linear displacement threaded bolt (11), the rotatable member being supported by bearings (15, 16) and drivable in rotation by the motor portion, characterised in that the linear actuator further includes an axially compressible coil spring (19) mounted in a compressed state between a valve head (37) arranged at an end of the threaded bolt (11) and a casing of the actuator, the threaded portion (10) of the threaded bolt comprising at least one thread arranged at an angle α relative to a plane orthogonal to the axial direction of motion of the threaded bolt, where the characteristic tan (α) is greater than the friction coefficient μ between the threaded bolt and the rotatable member so that the threaded bolt is reversible.

8. An actuator according to claim 7, wherein the threaded portion of the threaded bolt includes at least two threads.

9. An actuator according to claim 7, wherein the coil spring is mounted outside the actuator and around a cover portion (13) which forms part of the casing of the actuator.

10. An actuator according to claim 7, further including a partition wall (4) separating the motor portion from the actuator device portion and having a wall portion extending in an air gap (8) between the motor portion and the rotatable member of the actuator portion, the partition wall being also a structural component enabling assembly and position of the motor portion and the actuator portion.

11. An actuator according to claim 10, wherein the casing of the actuator includes a cover (13) comprising an actuator bearing portion, wherein the rotatable member, bearings and cover (13) are insertable axially into a cavity formed by the partition wall (4), the cover (13) being force-fitted into a matching cavity of the partition wall (4).

12. An actuator according to claim 11, wherein the actuator includes a body portion (14) provided at an end of the rotatable member distal from the cover (13) and comprising a bearing portion (16), wherein said body portion (14) is axially insertable into the partition wall (4) to abut axially against the partition wall, via elastic means (26).
